(19) United States
(12) Patent Application Publication
(10) Pub. No.: US 2005/0152128 A1
(43) Pub. Date: Jul. 14, 2005

(54) Switch plate lens assembly

(76) Inventor: James P. Campman, Transfer, PA (US)

Correspondence Address: DANIEL K. DORSEY, 400 FIFTH STREET, N.W., SUITE 300, WASHINGTON, DC, 20001, US

(21) Appl. No.: 11/020,359

(22) Filed: Dec. 27, 2004

Related U.S. Application Data
(60) Provisional application No. 60/536,239, filed on Jan. 14, 2004.

(51) Int. Cl. F21V 33/00

(52) U.S. Cl. 362/95

(57) ABSTRACT

The present invention relates to a switch plate assembly having a night light-type illumination device or a switch plate with a light source formed of a plurality of colored (red, blue, and green) LEDs. In one embodiment, the LEDs are covered by a pair of translucent, arcuate diffusers in series. The diffusers aid in uniformly or evenly dispersing the generated colored light from the cover plate or night light housing. The desired colors are generated in varying intensity for each LED. Each embodiment includes color generation control for performing a response based on a sensed condition such as a fire alarm, a doorbell, or burglar alarm. The light system can also be wired to an alarm signal generation system.

### BACKGROUND OF THE INVENTION

1. Field of the Invention

The present invention relates to switch plate lens assemblies. More specifically, the present invention relates to a switch plate assemble with a diffusion lens, a switch plate assembly with three individual lens mounted therein and a switch plate assembly with a frosted plexiglass lens. Each of the switch plate assemblies can be utilized as a night light-type illumination device or a switch plate with a light source formed of a plurality of colored (red, blue, and green) LED's.

2. The Prior Art

U.S. Pat. No. 5,481,442 to Dickie et al. is directed to a night light integral with a low profile cover plate assembly for electrical wall outlets utilizes two parts, a wall plate and a cover plate. The wall plate has a flat rear panel which is attached to the wall outlet, lies against the wall and includes peripheral lips holding a plurality of detent ridges. The cover plate includes the night light assembly which, in turn, includes power blades engaging the slots of the wall outlet to energize a night light bulb. Light escapes from underneath the cover plate through clear plastic lenses filling openings in the cover plate. Snap action projections on the inner surfaces of the cover plate periphery engage the retention ridges on the outer surfaces of the wall plate to ensure that the cover plate night light is attached to the wall plate by forces other than simply the friction of the power blades in the outlet slots. The cover plate may simultaneously be used to cover a low profile plug in the other outlet slots of a standard duplex wall outlet.

U.S. Pat. No. 6,431,719 to Lau et al. is directed to a self-contained night light that is disposed in a housing containing spaced-apart male AC prongs that mate with an AC socket. The housing contains an array of differently colored, preferably light emitting diodes. Light sources that can dynamically output different patterns of differently colored light in response to drive signals. A microcontroller executes a sequence of instructions causing the controller to output different sequences of signals that are coupled to a driver unit that drives the light sources. The result is that the array dynamically produces different patterns of differently colored light. A user operable control allows a viewer to “freeze” any desired pattern of light, such that until reset, the night light will continue to output a static pattern of colors. The night light may include a manual or light-sensing ON/OFF switch.

U.S. Pat. No. 6,604,839 to Coleman et al. is directed to a light emitting device which includes a diffractive optical element, a first light emitting diode emitting first light having a first range of wavelengths, and a second light emitting diode emitting second light having a second range of wavelengths. The first light is directed onto the diffractive optical element at a first range of angles of incidence, and the second light is directed onto the diffractive optical element at a second range of angles of incidence. The diffractive optical element diffracts at least a portion of the first light and at least a portion of the second light into the same range of angles of diffraction to obtain light having a desired range of wavelengths.

U.S. Pat. No. 6,536,914 to Hoelen et al. is directed to an illumination system for illuminating a display device comprising a light-emitting panel having a light-emission window and at least one edge surface for coupling light into the light-emitting panel. The illumination system further comprises a light mixing chamber provided with a light source. The light mixing chamber is associated with the edge surface. According to the invention, the light source comprises a plurality of clusters of light-emitting diodes (LEDs) having different light-emission wavelengths, the clusters being arranged at a pitch P with respect to each other. The ratio of the height H of the light mixing chamber to the pitch P of the clusters meets the relation 0.1.ltoreq.H/P.ltoreq.10, preferably 0.2.ltoreq.H/P.ltoreq.2. Preferably, each cluster comprises one blue, one green and one red LED, or one blue, two green and one red LEDs. Preferably, each LED has a luminous flux of at least 5 lumen.

U.S. Pat. No. 6,264,346 to Pashley et al. is directed to a faceted surface that has first and second facets which deflect respective first and second light beams to produce first sub-beams which alternate with second sub-beams. The faceted surface is a reflector having first facets at 120 degrees to second facets for mixing light beams which are incident at 120 degrees to each other. 100% of reflected sub-beams from each source alternate with 100% of sub-beams from the other source.

U.S. Pat. No. 6,241,363 to Lee is directed to a colored light mixing device which has one light source set and a color mixing plate. The light source set has three light generating units which generate light of different colors. The color mixing plate is made of transparent material, having a lower surface that faces the one light source set with a lower wavelike pattern and an upper surface opposite thereto with an upper wavelike pattern that is oriented differently from the lower wavelike pattern. Being hit by light from at least one light source set, the lower wavelike pattern acts as a plurality of linear light sources for light of mixed colors inside the color mixing plate being illuminated by light from the lower wavelike pattern, the upper wavelike pattern emits light of uniform intensity and mixed hue.

U.S. Pat. No. 5,453,918 to Hernandex et al. discloses a simple color illumination-type place for stages, dance floors, and ceilings. Apparatus for color illumination of stages, dance floors, skating rinks and the like. Prismatic plates made of a material transparent to light each have parallel triangular prisms. The prisms have an apex of 60 degrees and light sources emitting different primary color light incident on the opposite sides of the individual prisms result in combined beams of primary colors to be emitted by the individual prisms having a width corresponding to a width of a corresponding prism emitting the combined beam. The prismatic plates can be arranged so that the combined beams of the prisms of one prismatic plate are incident on a second prismatic plate having an independent light source emitting a third primary color incident thereon so that each combined beam emitted by the second prismatic plate prisms has three primary colors.

U.S. Pat. No. 4,990,821 to Blaisdell et al. is directed to a plug-in lamp assembly for use as a picture element in large-screen information display systems. The lamp assembly includes red, green and blue discharge lamps for selectively generating different colors. Each discharge lamp has electrical leads extending from a first end and a light output region at a second end. The lamp assembly further includes a base having spaced-apart, plug-in electrical connectors, a cap covering the second ends of the lamps and a sleeve around the discharge lamps and interconnecting the cap and the base. The base provides mechanical support for the discharge lamps and permits easy replacement of the lamp assembly. The sleeve blocks light emitted from the sides of the discharge lamps. The cap includes a diffuser and a filter for altering the output spectrum of one or more of the discharge lamps. The diffuser can be mounted in a spaced relationship to the second ends of the discharge lamps at a distance therefrom selected such that the light from each different color lamp substantially fills the area of the diffuser. As a result, the light outputs from the discharge lamps are merged at the diffuser.

### SUMMARY OF THE INVENTION

A need exists for a simple and reliable switch plate assembly with either at least three diode lenses, a double diffused lens or a plexiglass lens forming a night light-type illumination device or a switch plate with a light source formed of a plurality of colored (red, blue, and green) LEDs. In one embodiment, the LEDs are covered by a pair of translucent, arcuate diffusers in series. The diffusers aid in uniformly or evenly dispersing the generated colored light from the cover plate or night light housing. In each preferred embodiment, the desired colors are generated in varying intensity for each LED. Additionally, each preferred embodiment includes a color generation control to perform in response to a sensed condition. The sensed condition can be a fire alarm, a doorbell, or burglar alarm. Additionally, the light system can be wired to an alarm signal generation system.

Accordingly, it is an object of the invention to provide an apparatus including a switch plate assembly with a switch plate cover, at least one diffusion lens mounted in the switch plate assembly, the diffusion lens is made of white polypropylene with a corrugated wall, and two standard screw type assemblies or mounting members for securely mounting the switch plate cover to the switch plate assembly.

Another object of the invention is to provide a pair of plate cover screws, a UL approved electrical plastic box having switch plate cover holes for receiving the pair of plate screws to securely mount the switch plate cover to the electrical box, a base including mounting holes for receiving mounting screws, and the plastic electrical box having, adjacent to the switch plate cover holes, a pair of bracket receiving holes.

A further object of the invention is to provide a rectangularly shaped metal mounting bracket including mounting tabs for mounting the bracket to the plastic electrical box, the mounting tabs having mounting tab holes which are aligned with the bracket receiving holes of the plastic electrical box, the bracket having a bracket base and a pair of legs, each of the legs extends nearly perpendicular from the bracket base to the respective mounting tab, and each of the mounting tabs extend perpendicularly outward from the respective legs with the mounting tabs being parallel to the bracket base.

A still further object of the invention is to provide a pair of bracket mounting screws for entering each of the mounting tab holes and for entering the aligned bracket receiving holes to securely fasten the bracket mounting tabs and the bracket to the plastic electrical box.

An object of the invention is to provide a circuit board mounting to the bracket base, the circuit board including a control circuit with switches and a series of terminals connected to a light source.

Another object of the invention is to provide a plurality of colored LEDs including a color generation controller responding to a sensed condition, and the sensed condition being defined as a fire alarm, a doorbell, or burglar alarm, with the controller being wired to an alarm signal generation system.

It is an object of the invention to provide an apparatus comprising a switch plate assembly including a switch plate cover, at least three individual lenses mounted in the switch plate cover, the at least three individual lenses being a blue lens, a green lens and a red lens, and two mounting members being standard screw type assemblies for securely mounting the switch plate cover to the switch plate assembly.

It is an object of the invention to provide an apparatus comprising a switch plate assembly including a switch plate cover with a rectangular opening, a plexiglass lens mounted in the rectangular opening of the switch plate cover, and two mounting members being standard screw type assemblies for securely mounting the switch plate cover to the switch plate assembly.

Further scope of applicability of the present invention will become apparent from the detailed description given hereinafter. However, it should be understood that the detailed description and specific examples, while indicating preferred embodiments of the invention, are way of illustration only, since various changes and modifications within the spirit and the invention will become apparent to those skilled in the art from this detailed n.

### DESCRIPTION OF THE DRAWINGS

Preferred structural embodiments and preferred subcomponents of this invention are disclosed in the accompanying drawings in which:

FIG. 1 illustrates a switch plate assembly utilizing an embodiment with a double diffused lens in accordance with the present invention;

FIG. 2 illustrates a switch plate assembly utilizing an embodiment with three individual lenses in accordance with the present invention;

FIG. 3 illustrates a switch plate assembly utilizing an embodiment with plexiglass lens in accordance with the present invention;

FIG. 4 illustrates an exploded view of the switch plate assembly of FIG. 3 in accordance with present invention;

FIG. 5 illustrates a circuit in accordance with the present invention; and

FIG. 6A illustrates an end view of a switch plate cover of the switch plate assembly utilizing an embodiment with a double diffused lens in accordance with the present invention;

FIG. 6B illustrates a side view of the switch plate cover of the switch plate utilizing the embodiment with the double diffused lens in accordance with the present invention; and

FIG. 6C illustrates an end view of a switch plate cover of the switch plate assembly utilizing the embodiment with a double diffused lens in accordance with the present invention.

### DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

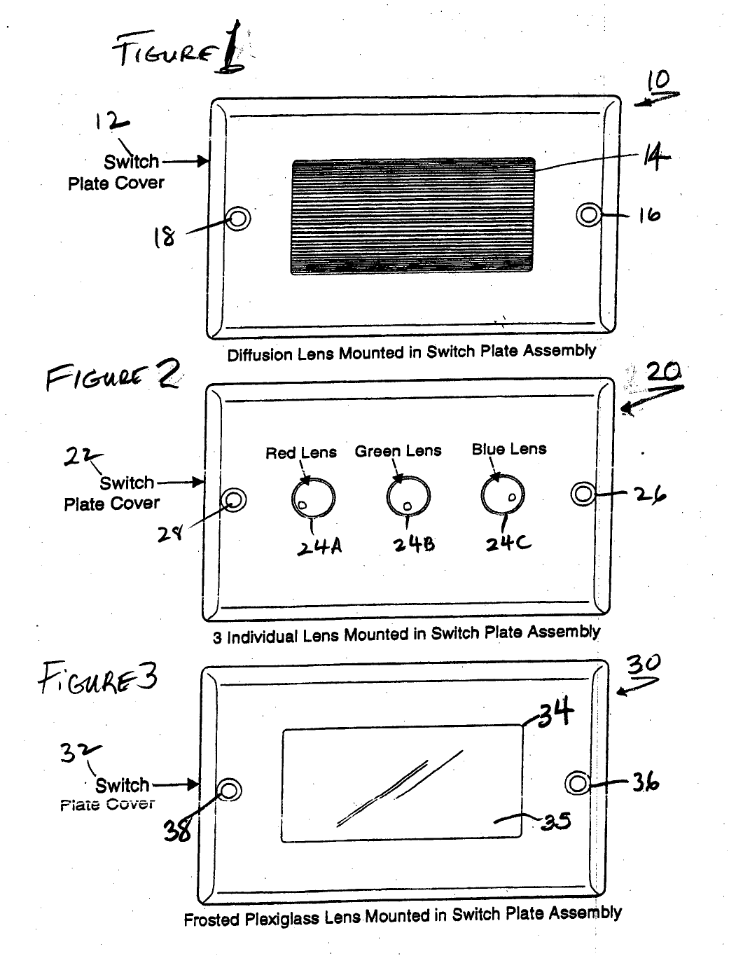

FIGS. 1, 2 and 3 illustrate top views of preferred embodiments of the switch plate assembly of the present invention. Each of the FIGS. 1, 2 and 3 will be explained separately, because of the different lens mountings. Where the assemblies have the same components, similar references will indicate such common components.

With reference now to FIG. 1, reference numeral 10 generally indicates the switch plate assembly shown in this figure. The switch plate assembly 10 comprises a switch plate cover 12 and a diffusion lens 14 which is mounted in the switch plate assemble 10. The diffusion lens 14 is made of white polypropylene with a wall thickness of 0.135 corrugated. The switch plate cover 12 includes two mounting members 16, 18 which are normally standard screw type assemblies.

FIG. 2 shows another embodiment of the switch plate assembly. In this figure, reference numeral 20 generally indicates the switch plate assembly shown. The switch plate assembly 20 comprises a switch plate cover 22 and three individual lenses; a red lens 24A, a green lens 24B and a red lens 24C, which are mounted in the switch plate assembly 20. This arrangement when used with the three basic color LEDs (red, blue, green) permits an easily mixing of colors which will be radiated from these light sources. The switch plate cover 22 includes two mounting members 26, 28 which are normally standard screw type assemblies similar to the two mounting members 16 and 18 as shown in FIG. 1.

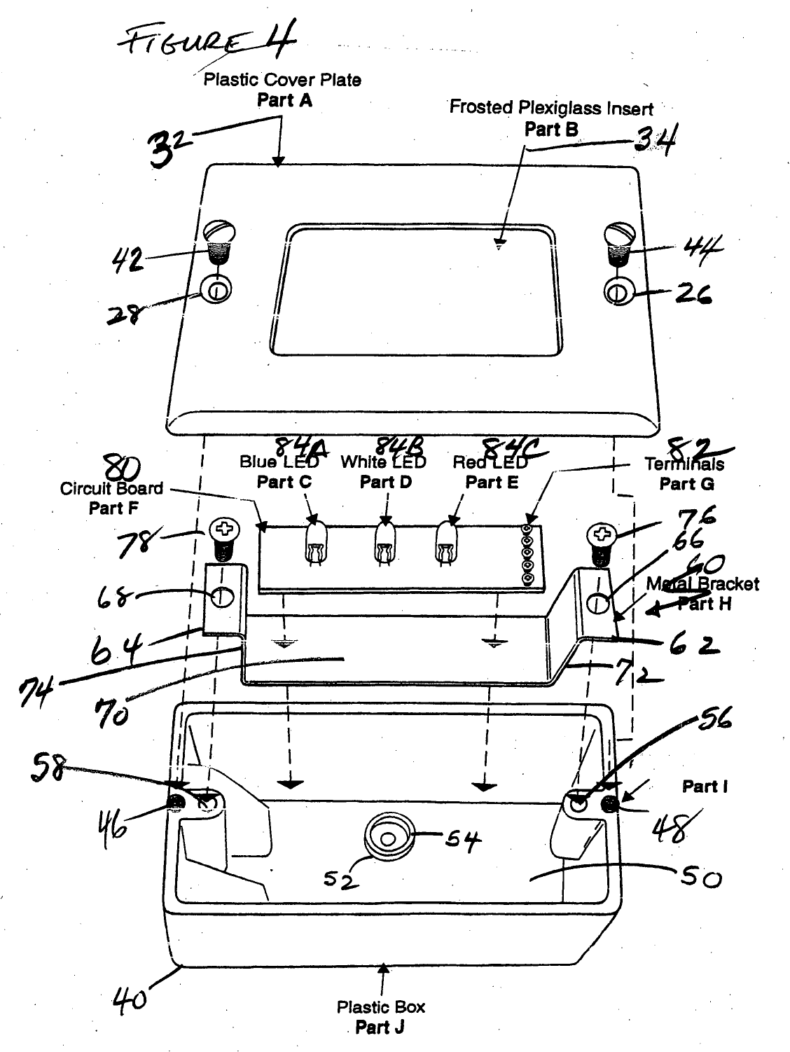

With reference now to FIG. 3, reference numeral 30 generally indicates the switch plate assembly shown in this figure. The switch plate assembly 30 comprises a switch plate cover 32 with a rectangular opening 34 for receiving a plexiglass lens 35 mounted in the switch plate assembly 30. The plexiglass lens 34, in this embodiment, is frosted. It is easily conceivable that this plexiglass lens could be clear as well as some other color. The switch plate cover 22 includes two mounting members 26, 28 which are normally standard screw type assemblies similar to the two mounting members 16 and 18 as shown in FIG. 1.

FIG. 4 illustrates an exploded view of inner components of the switch plate assemblies 10, 20 and 30. The switch plate assemblies 10, 20 and 30 are similar with respect to the inner components.

With reference to FIG. 4, generally shown is the switch plate assembly 20 and the rectangular opening 34. The plexiglass lens 35 is not shown. Any one of the three switch plate assemblies 10, 20 or 30 can be used with a UL approved electrical box, such as the electrical box 40 which is a plastic box. The switch plate cover 32 is plastic in the preferred embodiment and rectangular. The switch plate cover 32 fits all standard UL approved electrical boxes, such as the plastic box 40 shown in FIG. 4. As shown in the figure, screw assemblies 26, 28 receive plate cover screws 42 and 44. The electrical box has switch plate cover holes 46, 48 for receiving screws 42, 44 and securely mounting the switch plate cover 32 to the electrical box 40. The inner components of each of the switch plate assemblies 10, 20 and 30 will be described in FIG. 4.

Base 50 of the plastic electrical box 40 includes a mounting hole 52 for receiving a mounting screw 54. On either side of the plastic electrical box 40, next to the switch plate cover holes 46, 48 are bracket receiving holes 56, 58 for a metal mounting bracket, which is generally indicated by reference numeral 60. The metal mounting bracket 60 is rectangularly shaped with mounting tabs 62, 64 for mounting the bracket 60 on the plastic electrical box 40. The mounting tabs 62, 64 each have mounting tab holes 66, 68 which align with the bracket receiving holes 56, 58 of the plastic electrical box 40. The bracket 60 has a bracket base 70 and legs 72, 74. The legs 72, 74 extend roughly perpendicularly from the bracket base 70 to the mounting tabs 62, 64 and the mounting tabs 62, 64 extend perpendicularly outwardly from the legs 72, 74, such that the mounting tabs 62, 64 are parallel to the bracket base 70. With this arrangement, the bracket base 70 sits down in the plastic base 40, just above mounting hole 52 of the base 50. A pair of bracket mounting screws 76, 78 enter the mounting tab holes 66, 68 and then enter the aligned the bracket receiving holes 56, 58 to securely fasten the bracket mounting tabs 62, 64 and the bracket 60 to the plastic electrical box 40. A circuit board 80 is mounted to the bracket base 70. The circuit board 80 is generally shown and includes a series of terminals 82 as well as three LEDs, a blue LED 84A, a white LED 84B and a red LED 84C.

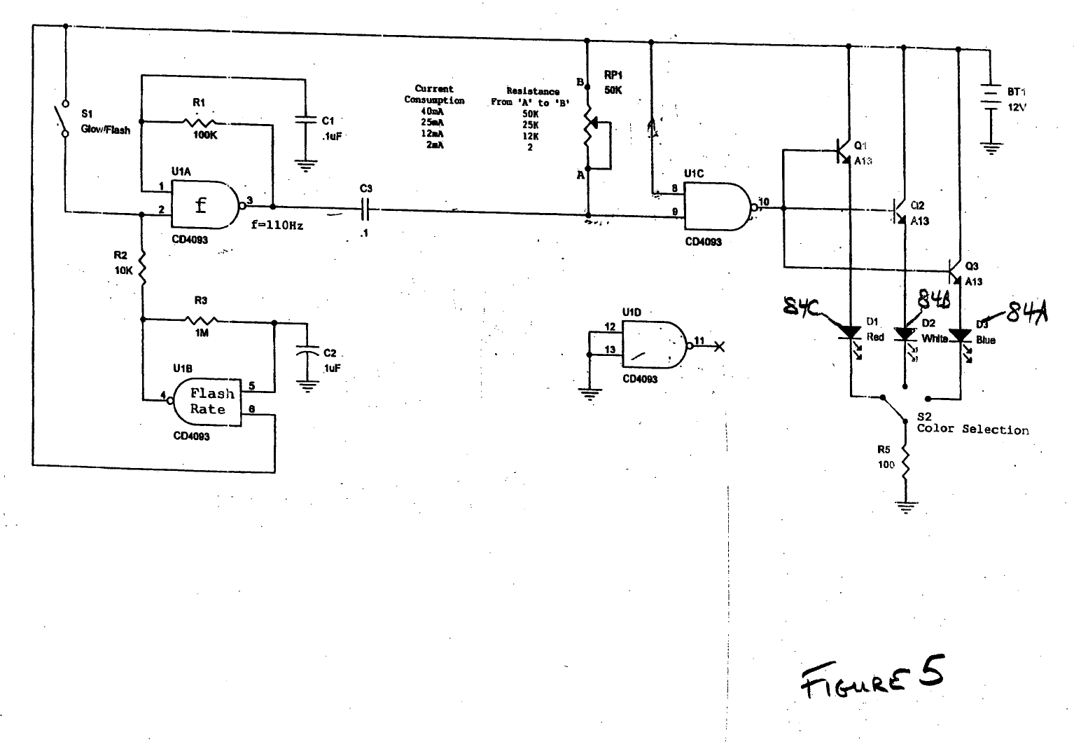

FIG. 5 illustrates the circuit board 80 which has been previously described as being mounted to the bracket base 70. Switch S1 can be set so that the LEDs 84A, 84B and 84C will either glow, strobe or flash. Switch S2 is switchable for color selection of the LEDs 84A, 84B, 84C. The circuit board 80 also includes a series of CD4093 gates U1A, U1B, U1C and U1D. The frequency of U1A is equal to 110 Hz. The board 80 also includes resistors and capacitors. The capacitors include C1 which is a 0.1 μf, C2 which is a 1.0 μf, and C3 which is a 0.1 μf. The resistors are R1 which is 100 k ohm, R2 which is a 10 k ohm, and R3 which is a 1.0 m ohm. There is also a RP1 50 k ohm which is adjustable from 2 k ohm to 50 k ohm. The current consumption is adjustable as well from 2 m amps to 40 m amps. There are two transistors Q1 and Q2, and the power supply is 12 volts.

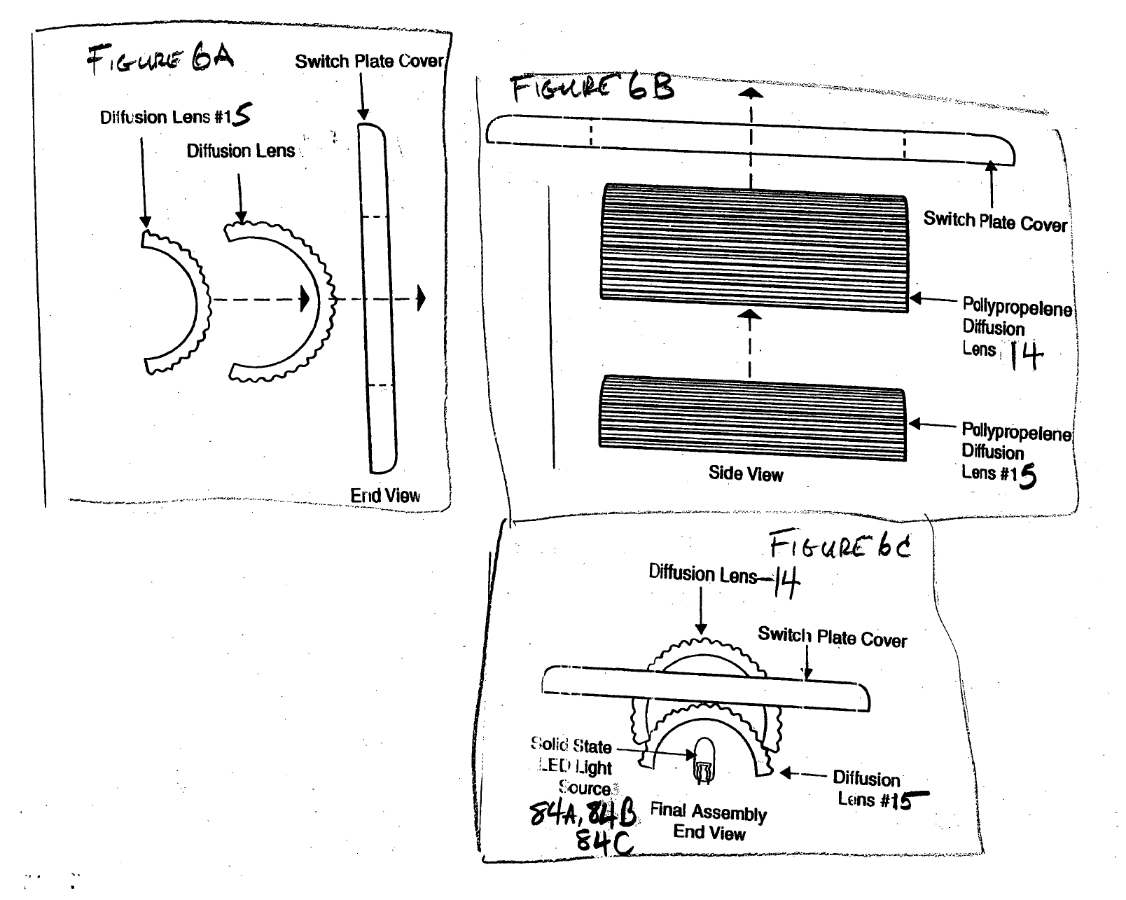

In FIGS. 6A, 6B and 6C, the large diffusion lens 14 accomplishes light diffusion from an LED source 84A, 84B and 84C whereas the small second lens 15 further diffuses the diffused LED light source 84A, 84B and 84C into a uniformly distributed soft light radiator. The result of this technique is a sentinel type night light that can be any color of the spectrum. The double diffused lenses 14, 15 may readily be flashed, strobed or steady glow. These assemblies, as depicted in FIG. 1, 2 or 3, show the versatility of application of this luminary assembly.

For example, any of the FIG. 1, 2, or 3 may easily be made to change color, such as when a fire alarm is activated, a burglar alarm is activated or a physically impaired hearing person can be alerted by a color change of the luminary. These arrangements as described can easily be retrofitted to any electrical outlet box or may be used in new construction. A simple example of application in new construction would be the night light (white light LED 84B) is permanently wired into the electrical system such that when night falls the light automatically comes on. The red LED 84C is wired to a low voltage door bell push button that caused the luminary to flash red when someone pushes the doorbell. The blue or green LED 84A (or other color) may be easily conveyed via the color changing properties of this night light color changing luminary.

Examples of various modes of operation when the various colors are either strobed or flashed may easily be indicative of other type alarms. The major utilitarian value of this device is that it easily blends in to room decor because it simply looks like another receptacle type device. The switch plate lens assemblies 10, 20 and 30 meet most electrical codes standards because these units are powered by low voltage (12 volts DC). Additionally, electronic assembly is compatible with all standard UL approved electrical work boxes. There is a choice of all colors of the spectrum. These colors may be flashed or strobed. The primary colors are easily mixed through the double diffusion polypropylene lens, resulting in all colors of the visible spectrum.

Some typical applications are as a night light using diffused white light with LED 84B, a telephone sentinel using the red LED 84C flashing light when telephone rings, as a door bell annunciate using a steady red LED 84C glow light when door bell is pushed, as a smoke alarm using a blue LED 84A as a flashing light, or burglar alarm using the blue LED 84A as a flow sentinel.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

1. An apparatus comprising:
a switch plate assembly including a switch plate cover;
at least one diffusion lens being mounted in the switch plate assembly, said diffusion lens being made of white polypropylene with a corrugated wall; and
two mounting members being standard screw type assemblies for securely mounting said switch plate cover to said switch plate assembly.

2. The apparatus of claim 1, wherein said switch plate assembly comprising:
a pair of plate cover screws; and
a UL approved electrical plastic box having switch plate cover holes for receiving said pair of plate screws, said pair of said plate screws securely mounting said switch plate cover to said electrical box, and a base including a mounting hole for receiving a mounting screw, said plastic electrical box having, adjacent to the switch plate cover holes, a pair of bracket receiving holes.

3. The apparatus of claim 2, wherein said switch plate assembly comprising:
a rectangularly shaped metal mounting bracket including mounting tabs for mounting said bracket to said plastic electrical box, said mounting tabs having mounting tab holes which are aligned with said bracket receiving holes of said plastic electrical box, said bracket having a bracket base and a pair of legs, each said legs extending nearly perpendicular from said bracket base to each said respective mounting tab, and said each mounting tab extend perpendicularly outward from said respective legs with said each mounting tab being parallel to said bracket base.

4. The apparatus of claim 3, wherein said switch plate assembly comprising:
a pair of bracket mounting screws for entering each of said mounting tab holes and for entering the aligned bracket receiving holes to securely fasten said bracket mounting tabs and said bracket to said plastic electrical box.

5. The apparatus of claim 4, wherein said switch plate assembly comprising:
a circuit board being mounted to said bracket base, said circuit board including a control circuit with switches and a series of terminals connected to a light source.

6. The apparatus of claim 5, wherein said light source being formed of said plurality of colored LEDs includes a color generation controller and said controller responds to a sensed condition, and said sensed condition being defined as a fire alarm, a doorbell, or burglar alarm, wherein said controller being wired to an alarm signal generation system.

7. An apparatus comprising:
a switch plate assembly including a switch plate cover;
at least three individual lenses mounted in said switch plate cover, said at least three individual lenses being a blue lens, a green lens and a red lens; and
two mounting members being standard screw type assemblies for securely mounting said switch plate cover to said switch plate assembly.

8. The apparatus of claim 7, wherein said switch plate assembly comprising:
a pair of plate cover screws; and
a UL approved electrical plastic box having switch plate cover holes for receiving said pair of plate screws, said pair of said plate screws securely mounting said switch plate cover to said electrical box, and a base including a mounting hole for receiving a mounting screw, said plastic electrical box having, adjacent to the switch plate cover holes, a pair of bracket receiving holes.

9. The apparatus of claim 8, wherein said switch plate assembly comprising:
a rectangularly shaped metal mounting bracket including mounting tabs for mounting said bracket to said plastic electrical box, said mounting tabs having mounting tab holes which are aligned with said bracket receiving holes of said plastic electrical box, said bracket having a bracket base and a pair of legs, each said legs extending nearly perpendicular from said bracket base to each said respective mounting tab, and said each mounting tab extend perpendicularly outward from said respective legs with said each mounting tab being parallel to said bracket base.

10. The apparatus of claim 9, wherein said switch plate assembly comprising:
a pair of bracket mounting screws for entering each of said mounting tab holes and for entering the aligned bracket receiving holes to securely fasten said bracket mounting tabs and said bracket to said plastic electrical box

11. The apparatus of claim 10, wherein said switch plate assembly comprising:
a circuit board being mounted to said bracket base, said circuit board including a control circuit with switches and a series of terminals connected to a light source.

12. The apparatus of claim 11, wherein said light source being formed of said plurality of colored LEDs includes a color generation controller and said controller responds to a sensed condition, and said sensed condition being defined as a fire alarm, a doorbell, or burglar alarm, wherein said controller being wired to an alarm signal generation system.

13. An apparatus comprising:
a switch plate assembly including a switch plate cover with a rectangular opening;
a plexiglass lens mounted in the rectangular opening of the switch plate cover; and
two mounting members being standard screw type assemblies for securely mounting said switch plate cover to said switch plate assembly.

14. The apparatus of claim 13, wherein said switch plate assembly comprising:
a pair of plate cover screws; and
a UL approved electrical plastic box having switch plate cover holes for receiving said pair of plate screws, said pair of said plate screws securely mounting said switch plate cover to said electrical box, and a base including a mounting hole for receiving a mounting screw, said plastic electrical box having, adjacent to the switch plate cover holes, a pair of bracket receiving holes.

15. The apparatus of claim 14, wherein said switch plate assembly comprising:
a rectangularly shaped metal mounting bracket including mounting tabs for mounting said bracket to said plastic electrical box, said mounting tabs having mounting tab holes which are aligned with said bracket receiving holes of said plastic electrical box, said bracket having a bracket base and a pair of legs, each said legs extending nearly perpendicular from said bracket base to each said respective mounting tab, and said each mounting tab extend perpendicularly outward from said respective legs with said each mounting tab being parallel to said bracket base.

16. The apparatus of claim 15, wherein said switch plate assembly comprising:
a pair of bracket mounting screws for entering each of said mounting tab holes and for entering the aligned bracket receiving holes to securely fasten said bracket mounting tabs and said bracket to said plastic electrical box.

17. The apparatus of claim 16, wherein said switch plate assembly comprising:
a circuit board being mounted to said bracket base, said circuit board including a control circuit with switches and a series of terminals connected to a light source.

18. The apparatus of claim 17, wherein said light source being formed of said plurality of colored LEDs includes a color generation controller and said controller responds to a sensed condition, and said sensed condition being defined as a fire alarm, a doorbell, or burglar alarm, wherein said controller being wired to an alarm signal generation system.
